(19) United States
(12) Patent Application Publication
(10) Pub. No.: US 2021/0353091 A1
(43) Pub. Date: Nov. 18, 2021

(54) SWEET TEA BREWING DEVICE

(71) Applicant: The Coca-Cola Company, Atlanta, GA (US)

(72) Inventors: Anila Lily Ann RAJESH, Cumming, GA (US); Holly Lynn McCORMICK, Atlanta, GA (US); David O. SLAGLEY, Roswell, GA (US); Jason Pate BARFIELD, Atlanta, GA (US)

(21) Appl. No.: 17/320,433

(22) Filed: May 14, 2021

Related U.S. Application Data
(60) Provisional application No. 63/052,738, filed on Jul. 16, 2020.
(60) Provisional application No. 63/025,630, filed on May 15, 2020.

(51) Int. Cl. A47J 31/06; A47J 31/40; A47J 31/41; A47J 31/50

(52) U.S. Cl. CPC A47J 31/0615; A47J 31/50; A47J 31/41; A47J 31/405

(57) ABSTRACT

The present application provides a sweet tea brewing device for brewing tea with hot water and adding sugar and dilution water. The sweet tea brewing device includes a tea basket for brewing the tea with the hot water, a sugar basket with the sugar downstream of the tea basket, a dilution line with the dilution water in communication with the sugar basket, and a tea urn downstream of the sugar basket. The tea from the tea basket and the dilution water from the dilution line dissolve the sugar in the sugar basket such that the combined tea, dissolved sugar, and dilution water flow to the tea urn.

### RELATED APPLICATIONS

The present application is a non-provisional application claiming priority to U.S. Provisional Application No. 63/025,630, filed on May 15, 2020, and U.S. Provisional Application No. 63/052,738, filed on Jul. 16, 2020.

### TECHNICAL FIELD

The present application and the resultant patent relate generally to brewing devices and more particularly relate to sweet tea brewing devices for dissolving sugar into the tea as the tea is brewed in a single step process.

### BACKGROUND OF THE INVENTION

Brewed sweet tea is one of the most popular fresh brewed offerings in restaurants, convenience stores, and other types of outlets. The process of making sweet tea generally involves adding granular sugar to the brewed tea in a tea urn or other type of container and stirring until the sugar is dissolved. For example, about three pounds of sugar may be added to a typical three gallon tea urn. This is a cumbersome and time consuming process that may be prone to inconsistencies in the sweetness and/or quality of the final beverage due to human error, lack of complete dissolving of the sugar, stratification, and other causes.

There is thus a desire for an improved brewing device that provides dissolved sugar or other types of sweeteners to the brewed tea or other type of brewed beverage in the correct proportions at the time of brewing in an automated and easy to use fashion.

### SUMMARY OF THE INVENTION

The present application and the resultant patent provide a sweet tea brewing device for brewing tea with hot water and adding sugar and dilution water. The sweet tea brewing device includes a tea basket for brewing the tea with the hot water, a sugar basket with the sugar downstream of the tea basket, a dilution line with the dilution water in communication with the sugar basket, and a tea urn downstream of the sugar basket. The tea from the tea basket and the dilution water from the dilution line dissolve the sugar in the sugar basket such that the combined tea, dissolved sugar, and dilution water flow to the tea urn.

The present application and the resultant patent further provide a method of brewing sweet tea. The method may include the steps of brewing tea with hot water in a tea basket, flowing the tea to a sugar basket with sugar therein, flowing dilution water to the sugar basket, dissolving the sugar in the tea and the dilution water, and flowing the combined tea, dissolved sugar, and dilution water to a tea urn.

These and other features and improvements of the present application and the resultant patent will become apparent to one of ordinary skill in the art upon review of the following detailed description when taken in conjunction with the shown drawings and the appended claims.

### BRIEF DESCRIPTION OF THE DRAWINGS

FIG. 1 is a side plan view of a known brewing device.

FIG. 2 is a side plan view of a sweet tea brewing device as may be described herein.

FIG. 3 is a partial side plan view of an alternative embodiment of the sweet tea brewing device of FIG. 2.

FIG. 4 is a side sectional view of an alternative embodiment of a sugar basket of the sweet tea brewing device of FIG. 2.

FIG. 5 is a top plan view of an alternative embodiment of a sugar basket of the sweet tea brewing device of FIG. 2.

FIG. 6 is a partial side plan view of an alternative embodiment of the sweet tea brewing device of FIG. 2.

FIG. 7 is a partial side plan view of an alternative embodiment of the sweet tea brewing device of FIG. 2.

FIG. 8 is a side sectional view of an alternative embodiment of a sugar basket of the sweet tea brewing device of FIG. 2.

FIG. 9 is a side plan view of an alternative embodiment of a sugar basket of the sweet tea brewing device of FIG. 2.

FIG. 10 is a side plan view of an alternative embodiment of a sugar basket of the sweet tea brewing device of FIG. 2.

FIG. 11 is a perspective view of an alternative embodiment of the sweet tea brewing device of FIG. 2.

FIG. 12 is a perspective view of an alternative embodiment of the sweet tea brewing device of FIG. 2.

FIG. 13 is a side plan view of an alternative embodiment of a tea basket and a sugar basket of the sweet tea brewing device of FIG. 2.

### DETAILED DESCRIPTION

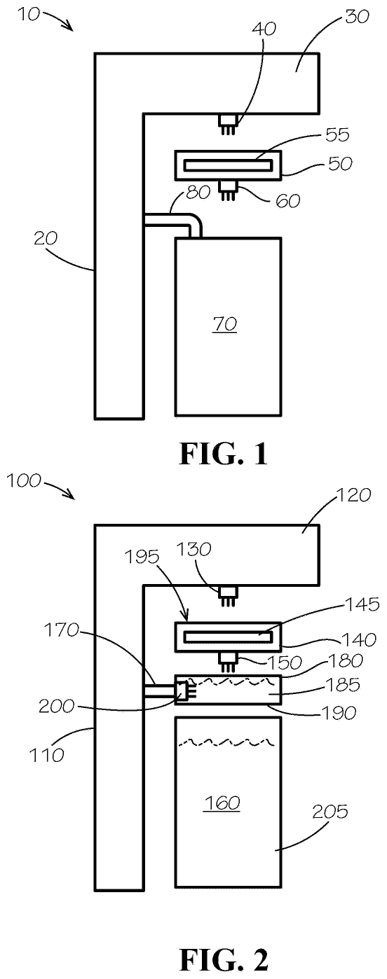

Referring now to the drawings, in which like numerals refer to like elements throughout the several views, FIG. 1 shows a known brewing device 10. The brewing device 10 includes an outer frame 20 with a water heater 30 therein. The water heater 30 has a hot water spout 40. The brewing device 10 further includes a tea basket 50 in communication with the hot water spout 40. The tea basket 50 includes a volume of tea leaves or other types of brewable material therein. The tea leaves may be in one or more tea bags 55 or other type of permeable packaging or loose tea may be held in a paper filter. The tea basket 50 may include a tea spout 60. The brewing device 10 further may include a tea urn 70. The tea urn 70 may have any convenient size, shape, or configuration. In this example, the tea urn 70 may have a conventional three gallon configuration. The brewing device 10 also may have a dilution water line 80. The dilution water line 80 may be in communication with the tea urn 70 or elsewhere to provide dilution water and the like. In a conventional manner, hot water from the water heater 30 flows into the tea basket 50 to brew the tea therein. The brewed tea flows into the tea urn 70 where dilution water may be added by the dilution water line 80. Sugar also may be manually added and stirred to dissolve. Other components and other configurations may be used herein.

FIG. 2 shows a sweet tea brewing device 100 as may be described herein. The figures are not drawn to scale. In a manner similar to that above, the sweet tea brewing device 100 may include an outer frame 110, a water heater 120 with a water spout 130, a tea basket 140 with one or more tea bags 145 and a tea spout 150, a tea urn 160, and a dilution line 170. In this example, the sweet tea brewing device 100 further includes a sugar basket 180 with a volume of granular sugar 185 therein. The granulation range of the sugar may vary from about USS screen 8 to about USS screen 200 with larger sizes preferred. The sugar basket 180 may have any suitable size, shape, or configuration.

The sugar basket 180 may be positioned between the tea basket 140 and the tea urn 160 with the tea basket 140 and the sugar basket 180 arranged in a top and bottom configuration 195. As will be described in more detail below, the sugar basket 180 may have an open mesh end 190 or other type of exit. The open mesh end 190 may be a metal mesh, a fabric mesh, combinations thereof, and the like. The tea spout 150 of the tea basket 140 thus may be in communication with the sugar basket 180 and the open mesh end 190 of the sugar basket 180 may be in communication with the tea urn 160. The dilution line 170 may be in communication with the sugar basket 180 or elsewhere. More than one dilution line 170 may be used. Other components and other configurations may be used herein.

The sugar basket 180 may be sized to permit all of the sugar therein to dissolve in the time of the typical brew cycle, e.g., about three pounds of sugar for three gallons of tea in a brewing cycle of about six to ten minutes. In use, hot water flows from the water spout 130 of the water heater 120 into the tea basket 140. The hot water seeps through the tea leaves to create the brewed tea. The brewed tea flows through the tea spout 130 into the sugar basket 180 and in contact with the sugar therein. More than one tea spout 130 may be used. At the same time, dilution water from the dilution line 170 also may flow into the sugar basket 180. The dilution line 170 may be configured with a sprayer head 200 to ensure continuous spraying of the sugar by the dilution water. The combination of the hot brewed tea brew and the dilution water ensures that all of the sugar is dissolved during the typical brewing cycle. The now sweetened tea 205 flows through the open mesh end 190 of the sugar basket 180 into the tea urn 160. The sweetened tea now may be served as desired.

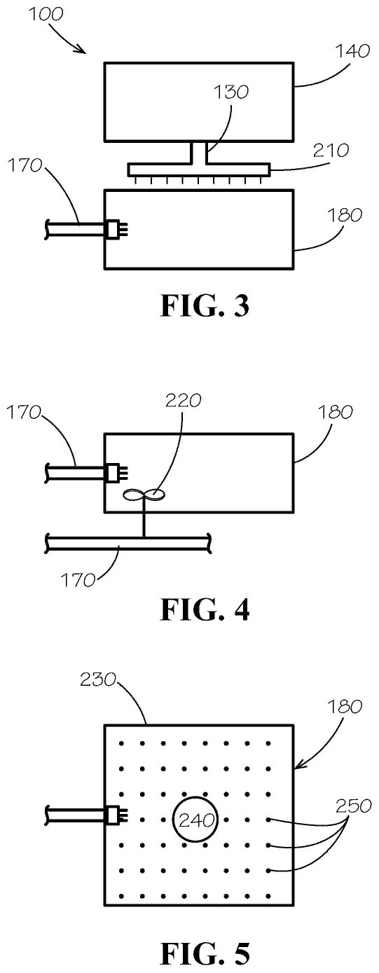

FIG. 3 shows an alternative embodiment of the sweet tea brewing device 100 as may be described herein. In this example, the tea spout 130 may lead to a manifold spray head 210 positioned over or within the sugar basket 180. The manifold spray head 210 may have any suitable size, shape, or configuration. The manifold spray head 210 ensures even spraying over the all of the sugar therein. The tea spout 130 and/or the manifold spray head 210 also may rotate for good water coverage. Other components and other configurations may be used herein.

FIG. 4 shows a further alternative embodiment of the sugar basket 180 for use with the sweet tea brewing device 100 as may be described herein. In this example, the sugar basket 180 may include a mechanical mixer 220 therein. The mechanical mixer 220 may have any suitable size, shape, or configuration. The mechanical mixer 220 may be driven by the water in the dilution line 170, by a separate flow source, and/or by electromechanical devices. Alternatively, the streams flowing into or exiting the tea basket 140 and/or the sugar basket 180 may be used to drive the mechanical mixer 220. The mixing action assist in dissolving the sugar into the tea. Other components and other configurations may be used herein.

FIG. 5 show a further alternative embodiment of the sugar basket 180 for use with the sweet tea brewing device 100 as may be described herein. In this example, the sugar basket 180 may include a dispersion pan 230 positioned thereon. The dispersion pan 230 may include a central aperture 240 for the tea spout 150 and any number of dispersion holes 250. The dispersion pan 230 may have any suitable size, shape, or configuration. The dispersion pan 230 may be in communication with the dispersion water line 170 such that dilution water flows evenly through the dispersion holes 250 for good water coverage of the sugar. The dispersion pan 230 alternatively also may define a water cavity and a mesh raised liner. Other components and other configurations may be used herein.

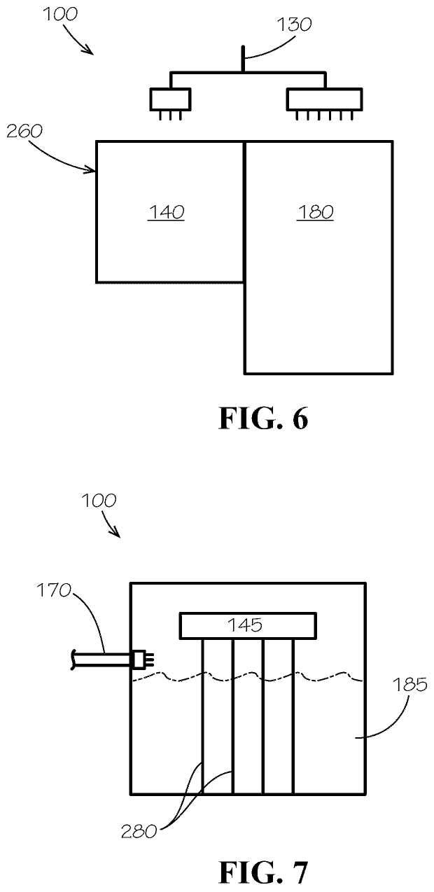

FIG. 6 show an alternative embodiment of the sweet tea brewing device 100 described herein. Instead of the tea basket 140 and the sugar basket 180 arranged in the top and bottom configuration 195 described above, here the tea basket 140 and the sugar basket 180 may be arranged in a side by side configuration 260. The tea basket 140 and the sugar basket 180 may be separate containers in a single material hopper or separate structures. The size and shape of the tea basket 140 and the sugar basket 180 may vary to accommodate differing brew times and dissolving times and/or the flow rates of the hot water through the tea basket 140 and the sugar basket 180 may vary. The brewed tea may have a separate exit such that the brewed tea and the dissolved sugar solution merge at some downstream point or the brewed tea may flow into the sugar basket 180 to aid in dissolving the sugar. Other components and other configurations may be used herein.

FIG. 7 shows a further alternative embodiment of the sweet tea brewing device 100 as may be described herein. In this example, a combined tea/sugar basket 270 is shown. The tea bag 145 may be supported above the sugar 185 by a number of support fins or rods 280 within the combined tea/sugar basket 270 or the tea bag 55 may be positioned directly on the sugar 185. The dilution water line 170 also may be used in this example. Other components and other configurations may be used herein.

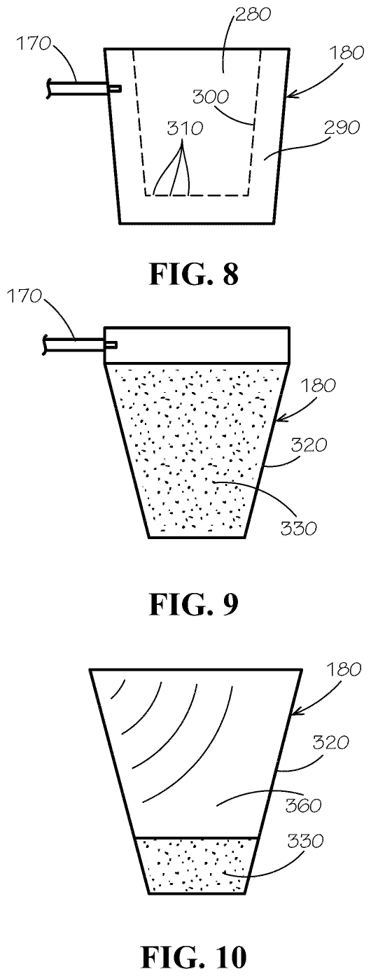

FIG. 8 shows a further alternative embodiment of the sugar basket 180 for use with the sweet tea brewing device 100 as may be defined herein. In this example, the sugar basket 180 may have an inner chamber 280 and an outer chamber 290 separated by a chamber divider 300. The chamber divider 300 may have a number of divider apertures 310 therein. The number, size, and shape of the divider apertures 310 may vary. Alternatively, a mesh divider also may be used. The inner chamber 280 holds the sugar therein. The dilution line 170 may be in communication with the outer chamber 290. The brewed tea from the tea basket 140 flows into the inner chamber 280 to dissolve the sugar. Dilution water also may flow from the outer chamber 280 into the inner chamber 290 to aid in dissolving the sugar. Other components and other configurations may be used herein.

FIG. 9 shows a further alternative embodiment of the sugar basket 180 for use with the sweet tea brewing device 100 as may be described herein. In this example, the sugar basket 180 may have a substantially conical shape 320. The sugar basket 180 may be made out of a mesh 330. The size of the apertures in the mesh 330 may vary. The conical shape 320 maintains the sugar where the water is flowing as opposed to, for example, a typical corner of a rectangular container that may have less water flow and therefore more undissolved sugar. Dilution water may be added from the dilution line 170 being in communication with a top dilution tray or a rim 340 positioned at the top of the cone 320. Other components and other configurations may be used.

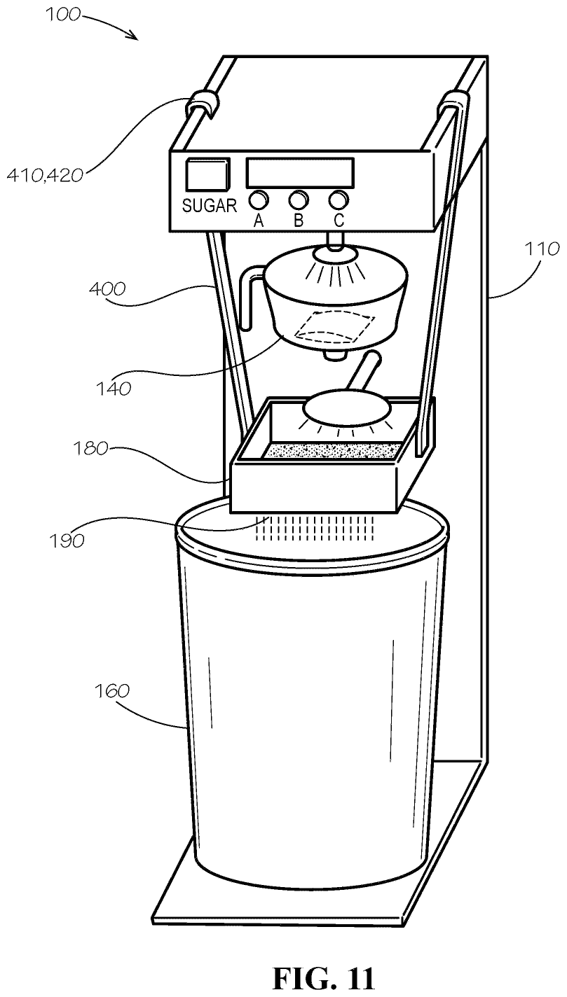

FIG. 10 shows a further alternative embodiment of the sugar basket 180 for use with the sweet tea brewing device 100 as may be described herein. In this example, the sugar basket 180 may again have the substantially conical shape 320. The sugar basket 180 may made out of a plastic 360 and/or a combination of the plastic 360 for a top portion and the mesh 330 for a bottom portion. The plastic portion of the cone 320 may have grooves or fins 360 formed therein to promote the downward movement of the sugar. Other components and other configurations may be used herein.

FIG. 11 shows a further embodiment of a sweet tea brewing device 100 as may be described herein. In this example, the sugar basket 180 may have a pair of support arms 400 on either side thereof that extend upwardly and around the tea basket 140. Each support arm 400 may have a hook 410 on the upper end thereof. Each hook 410 may fit into a groove 420 formed in the top end of the outer frame 110. Other types of connection means may be used herein. The use of the support arms 400 may give the sugar basket 180 some amount of swing for easy positioning. The sugar basket 180 may use the modified manifold spray head 210 on top and the mesh bottom 190. Other components and other configurations may be used herein.

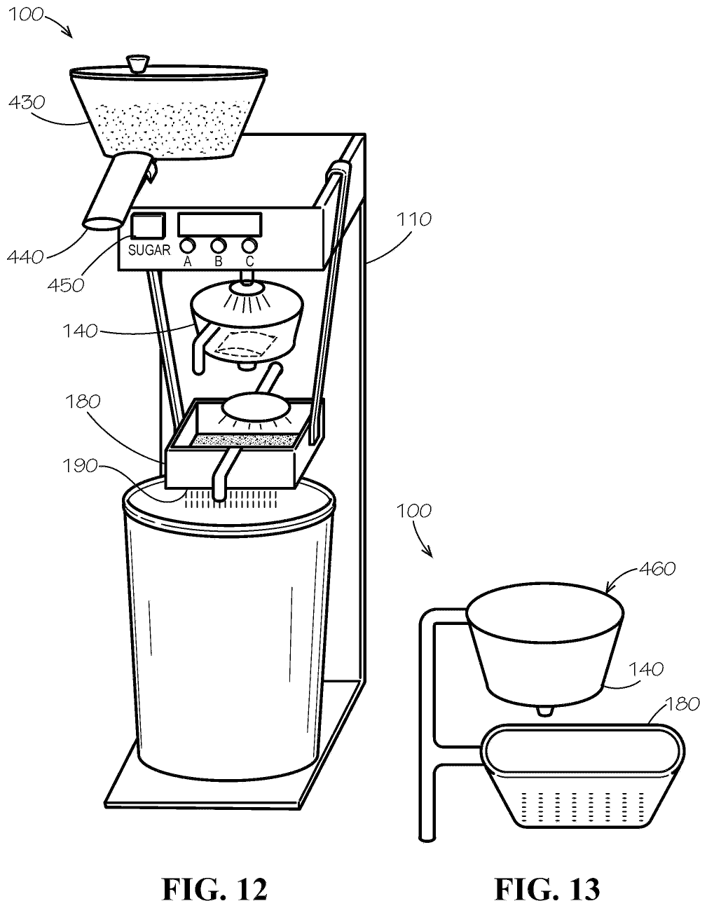

FIG. 12 shows a further embodiment of a sweet tea brewing device 100 as may be described herein. In this example, a sugar hopper 430 may be attached to the top or side of the outer frame 110 about the sugar basket 180. The sugar hopper 430 holds a volume of bulk sugar therein. The sugar hopper 430 may have a dispensing chute 440 in communication with the sugar basket 180. A portion controlled sugar dispense control button 450 may be positioned on the outer frame 110 or elsewhere. The portion controlled sugar dispense control button 450 may dispense a pre-weighed amount of sugar to flow into the sugar basket 180 under the force of gravity or otherwise. Specifically, sugar that can be dispensed in a portion controlled manner, such that a precise quantity of sugar /per brew cycle is used to maintain quality of sweet tea. The portion controlled sugar dispense control button 450 may be mechanical or electromechanical. Other components and other configurations may be used herein.

FIG. 13 shows a further embodiment of a sweet tea brewing device 100 as may be described herein. In this example, a combined tea basket and sugar basket 460 is shown. The combined tea basket and sugar basket 460 combines the tea basket 140 and the sugar basket 180 in a single unit. The combined tea basket and sugar basket 460 thus may be installed and removed as the single unit. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A sweet tea brewing device for brewing tea with hot water and adding sugar and dilution water, comprising:
a tea basket for brewing the tea with the hot water;
a sugar basket with the sugar downstream of the tea basket;
a dilution line with the dilution water in communication with the sugar basket; and
a tea urn downstream of the sugar basket;
wherein the tea from the tea basket and the dilution water from the dilution line dissolve the sugar in the sugar basket such that the combined tea, dissolved sugar, and dilution water flow to the tea urn.

2. The sweet tea brewing device of claim 1, further comprising a water heater and water spout upstream of the tea basket.

3. The sweet tea brewing device of claim 1, wherein the tea basket and the sugar basket comprise a top to bottom configuration.

4. The sweet tea brewing device of claim 1, wherein the tea basket comprises a mesh bottom end.

5. The sweet tea brewing device of claim 1, wherein the tea basket comprises one or more tea spouts in communication with the sugar basket.

6. The sweet tea brewing device of claim 5, wherein the tea spout comprises a manifold spray head.

7. The sweet tea brewing device of claim 5, wherein the tea spout comprises a rotating spray head.

8. The sweet tea brewing device of claim 1, wherein the sugar basket comprises a mechanical mixer therein.

9. The sweet tea brewing device of claim 1, wherein the sugar basket comprises a dispersion pan thereon in communication with the dilution line.

10. The sweet tea brewing device of claim 1, wherein the tea basket and the sugar basket comprise a side by side configuration.

11. The sweet tea brewing device of claim 1, wherein the tea basket and the sugar basket comprise a combined tea/sugar basket.

12. The sweet tea brewing device of claim 1, wherein the sugar basket comprises an inner chamber and an outer chamber.

13. The sweet tea brewing device of claim 12, wherein the sugar basket comprises a chamber divider with a number of divider apertures therein.

14. The sweet tea brewing device of claim 1, wherein the sugar basket comprises a conical shape.

15. The sweet tea brewing device of claim 14, wherein the conical shape comprises mesh and/or plastic.

16. The sweet tea brewing device of claim 1, wherein the sugar basket comprises a pair of support arms with a hook thereon.

17. The sweet tea brewing device of claim 1, further comprising a sugar hopper in communication with the sugar basket.

18. The sweet tea brewing device of claim 1, wherein the tea basket and the sugar basket comprise a combined tea basket and sugar basket.

19. The sweet tea brewing device of claim 1, wherein the sugar comprises a granulation range from about USS screen 8 to about USS screen 200.

20. A method of brewing sweet tea, comprising:
brewing tea with hot water in a tea basket;
flowing the tea to a sugar basket with sugar therein;
flowing dilution water to the sugar basket;
dissolving the sugar in the tea and the dilution water; and
flowing the combined tea, dissolved sugar, and dilution water to a tea urn.
